(19) United States
(12) Patent Application Publication
(10) Pub. No.: US 2006/0177628 A1
(43) Pub. Date: Aug. 10, 2006

(54) Carrier assembly with fused powder and frame-warp aperture and embedding composite strip

(75) Inventors: William Whitehead, Maryville, TN (US); Michael J. Usher, Rock Hill, SC (US)

Correspondence Address: Stephen B. Salai, Esq.;Harter, Secrest & Emery LLP, 1600 Bausch & Lomb Place, Rochester, NY, 14604-2711, US

(73) Assignee: Schlegel Corporation, New York, NY (US)

(21) Appl. No.: 11/349,754

(22) Filed: Feb. 8, 2006

Related U.S. Application Data
(63) Continuation-in-part of application No. 11/054,485, filed on Feb. 9, 2005.

(51) Int. Cl. B32B 5/12

(52) U.S. Cl. 428/105

(57) ABSTRACT

A composite strip having a polymeric body embedding a carrier assembly is provided, wherein the composite strip can be formed into a vehicle flange engaging strip such as a weatherstrip or trim strip. The carrier assembly includes a serpentine frame and a warp interlaced with the frame to form at least one frame-warp aperture. A fused powder bonds to at least one of the serpentine frame and the warp and inhibits movement of the warp relative to the frame, substantially preserving the frame-warp aperture. A polymeric body at least partially embeds the serpentine frame, the warp and the fused powder.

### CROSS-REFERENCE TO RELATED APPLICATIONS

The present application is a continuation-in-part of U.S. application Ser. No. 11/054,485 filed Feb. 9, 2005, herein expressly incorporated by reference.

### STATEMENT REGARDING FEDERALLY SPONSORED RESEARCH OR DEVELOPMENT

Not applicable.

### REFERENCE TO A “SEQUENCE LISTING”

Not applicable.

### BACKGROUND OF THE INVENTION

1. Field of the Invention

The present invention relates to a vehicular composite strip such as a finishing strip, a trim strip or a sealing strip having a reinforcing carrier assembly. More particularly, the present invention relates to a composite strip incorporating a carrier assembly having a serpentine frame, a warp connected to the frame so as to define a frame-warp aperture, wherein movement of the warp relative to the serpentine frame is inhibited by a fused powder on at least one of the frame and the warp, and at least a substantial portion of the frame-warp aperture is preserved.

2. Description of Related Art

Wire carriers are used as a reinforcing frame for extrusion products, such as motor vehicle strips. The wire carriers typically include a continuous wire weft formed into a zig-zag shape with warp threads on the limbs. During manufacture of the motor vehicle strips, the wire carrier is passed through an extruder and is thus subjected to stresses and temperatures which can cause the warp threads to drift laterally, stretch longitudinally and degenerate. Such processing of the wire carrier can result, for example, in breakage of the warps and distortion of the wire carrier which affects the subsequent extrusion process and leads to reduced quality and performance of the resulting vehicular strip. In the forming and extrusion processes, drifting of the warp threads can cause air bubbles and exposure of the wire in the final product. In addition, the shifting of the warp threads can lead to unbalanced locations of the warp threads in the resulting vehicular strip, which can lead to the strip “laying over” upon installation on a vehicle.

In addition, movement of the warp threads during the extrusion process can impart a spiral to the resulting vehicular strip. The tendency of the vehicular strip to spiral significantly hinders installation of the strip on a vehicle. Further, unintended redistribution of the warp threads can lead to a “hungry horse” appearance in the resulting strip as the wire produces corresponding surface features.

There has long been a need to develop a stable wire carrier which overcomes these problems and many attempts have been made without complete success.

EP 0384613 discloses a knitted wire carrier in which stitched warp threads comprise two threads of polymeric material having different melting points such that when the melting point of the lower melting thread is exceeded the melted thread causes the other thread to be attached to the wire weft. This structure allows single strands of warp thread plied with a meltable filament to be bonded to the wire carrier wherever they are knitted.

U.S. Pat. No. 5,416,961 to Vinay discloses a knitted wire carrier comprising at least one meltable filament laid-in into at least two adjacent warp threads, whereby on heating, the melted filament causes the at least two adjacent warp threads to be bonded to the wire and/or to each other for stabilizing the resulting wire carrier against warp drift.

In spite of these issues, the wire carrier provides substantial benefits. Specifically, the wire carrier exhibits an inherent flexibility about three axes, which in turn provides good handling characteristics of the finished product. Further, in contrast to many stamped metal and lanced and stretched metal carriers, the wire carrier is able to bear relatively high loading, particularly during the extrusion process. In addition, the wire carrier has the benefit of withstanding greater flexing without exhibiting metal fatigue.

Thus, there is a need to develop a stable wire carrier for extruded and molded polymeric products. The need also exists for a carrier assembly with reduced or negligible warp drift, thereby overcoming the problems associated with warp drift.

### BRIEF SUMMARY OF THE INVENTION

The present invention encompasses a carrier assembly with stable and predictable warp locations which provide improved consistency and quality of the carrier assembly and hence improved consistency and quality of any subsequent vehicular strip which incorporates the carrier assembly.

The carrier assembly includes a serpentine frame, a warp extending along the frame, wherein the warp and the serpentine frame define a frame-warp aperture, and a fused powder on at least a portion of one of the frame and the warp. The fused powder impedes movement of the warp relative to the frame and preserves at least a substantial portion of the frame-warp aperture.

The fused powder can be located at a junction of the frame and the warp. In an alternative configuration, the fused powder can be located primarily on the frame. In a further configuration, the fused powder can encapsulate at least a portion of the frame and the warp. Alternatively, the fused powder can occlude a stitch gap formed by the warp and the serpentine frame. In each configuration, at least a substantial portion of the frame-warp aperture is preserved.

In selected configurations, the serpentine frame is formed from a metallic or polymeric material and defines a plurality of limbs interconnected at alternate ends by connecting regions. The warp can include a single or a plurality of threads or yarns interlaced with the limbs of the serpentine frame to define frame-warp apertures.

The fused powder is readily deposited on the serpentine frame and the warp and can be fused to inhibit movement of the warp relative to the frame, and particularly inhibit movement of the warp transverse to a longitudinal dimension of the frame while preserving the frame-warp aperture.

The carrier assembly can be formed by powder coating the serpentine frame and an interlaced warp, interlacing the warp on a powder coated serpentine frame or interlacing a powder coated warp with the serpentine frame.

In a further configuration, the composite strip is provided with the serpentine frame; at least one warp contacting the frame along a longitudinal dimension of the frame; a fused powder on at least one of the frame and the warp; and an elongate polymeric body at least partially embedding the serpentine frame, the warp and the fused powder.

In selected configurations, the warps can include a degradable warp, wherein the degradable warp can be selectively degraded after formation of the composite strip.

As the warps are retained relative to the serpentine frame and do not materially drift relative to the frame, the composite strip can be notched in predetermined locations, wherein the notch is spaced from the embedded warp by a portion of the polymeric body.

The carrier assembly can include a plurality of stitch gaps in addition to the plurality of frame-warp apertures, wherein the fused powder substantially occludes the plurality of stitch gaps and preserves the plurality of the frame-warp apertures.

It is also contemplated the composite strip incorporating the carrier assembly with the fused powder will shrink less along the longitudinal direction than a corresponding composite strip having a carrier assembly that is free of fused powder.

The carrier assembly also reduces manufacturing steps for creation of the composite strip. Specifically, the carrier assembly can be disposed about a take-up spool downstream of a knitter and then introduced to an extruder from the take-up spool. As the carrier assembly is disposed on the take-up spool, the carrier assembly has a bound end proximal to the spool and a free end, wherein the carrier assembly has a first tendency of longitudinal unraveling from the free end to the bound end and a lesser second tendency of longitudinal unraveling extending from the bound end to the free end. Thus, the carrier assembly can be fed to an extruder with an unraveling vector directed upstream of the carrier assembly.

### BRIEF DESCRIPTION OF THE SEVERAL VIEWS OF THE DRAWING(S)

FIG. 1 is a top plan view of a representative carrier assembly.

FIG. 2 is a cross-sectional view of a vehicular weather strip incorporating a configuration of the carrier assembly.

FIG. 3 is a top plan view of the serpentine frame having parallel limbs.

FIG. 4 is a top plan view of the serpentine frame having curvilinear limbs and connecting regions.

FIG. 5 is a top plan view of the serpentine frame having tapered connecting regions.

FIG. 6 is a top plan view of the serpentine frame having faceted limbs and curvilinear connecting regions.

FIG. 7 is a top plan view of the serpentine frame having a first connecting region configuration along one edge of the frame and a different second connecting region configuration along a second edge of the frame.

FIG. 8 is a top plan view of the serpentine frame having parallel limbs and a plurality warps interlaced with the frame.

FIG. 9 is a top plan view of the serpentine frame having curvilinear shaped limbs and a plurality of warps interlaced with the frame.

FIG. 10 is a top plan view of the serpentine frame having curvilinear shaped limbs and a different configuration of warps interlaced with the frame.

FIG. 11 is an enlarged cross-sectional schematic view showing the fused powder encapsulating a portion of the serpentine frame and the warp.

FIG. 12 is a schematic cross-sectional view of a fused powder on a portion of the serpentine frame engaging a warp.

FIG. 13 is a perspective cut away view of the carrier assembly embedded within a polymeric body.

FIG. 14 is a top plan view of the serpentine frame having curvilinear shaped limbs and a configuration of warps interlaced with the frame, wherein selected warps are meltable (phantom) warps.

FIG. 15 is a cross sectional view showing the polymeric body and a plurality of warps including degradable warps prior to degradation.

FIG. 16 is a perspective view of the carrier assembly in an extruded polymeric body, wherein a portion of the body has been notched to assist in operable installation of the finished product.

FIG. 17 is a perspective schematic of the carrier assembly showing frame-warp apertures and stitch gaps.

FIG. 18 is a schematic cross sectional view of the carrier assembly showing the stitch gaps.

FIG. 19 is a schematic side elevational view of the carrier assembly of FIG. 18 showing filled stitch gaps.

FIG. 20 is a schematic view of the formation of a take up spool of the carrier assembly.

FIG. 21 is a schematic view of the presentation of the take up spool of the carrier assembly to an extruder, via an optional pre-former.

FIG. 22 is a schematic view of the re-winding of the carrier assembly from the take-up spool to a presenting spool prior to introduction of the carrier assembly to an extruder.

FIG. 23 is a is a schematic view of the carrier assembly being introduced from the presenting spool to an extruder, via an optional pre-former.

FIG. 24 is a schematic view of a length of the composite strip at different time periods after formation of the polymeric body.

### DETAILED DESCRIPTION OF THE INVENTION

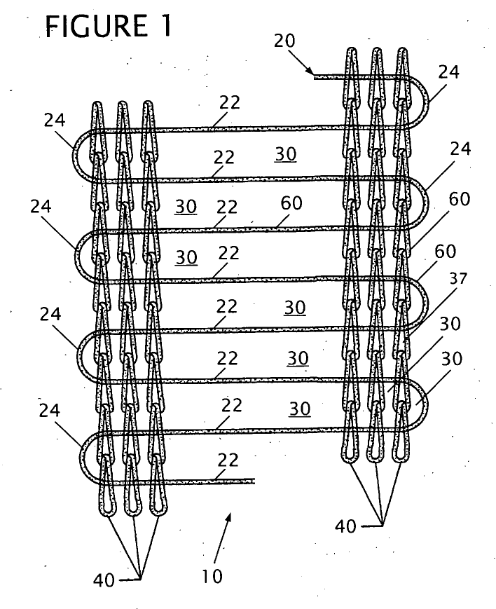

A carrier assembly 10 in accordance with the present invention is shown in FIG. 1. The carrier assembly 10 includes a serpentine frame 20, at least one warp 40 and a fused powder 60 on at least one of the frame and the warp to define at least one frame-warp aperture 30.

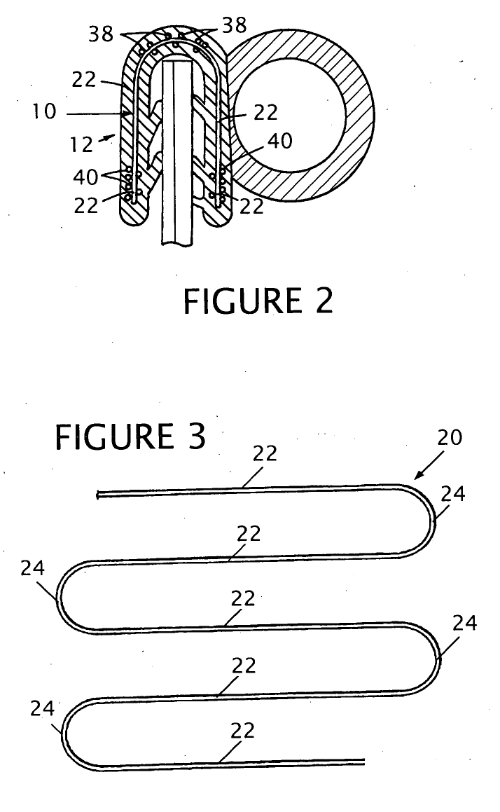

Referring to FIG. 2, the carrier assembly 10 can be incorporated into any of a variety of motor vehicle finishing strips, trim strips or weather strips. A vehicular composite strip 12, such as a weatherstrip includes a polymeric body 50 embedding the carrier assembly 10 is shown in FIG. 2. It is understood the vehicular composite strips can have any of a variety of configurations for engaging a vehicle, such as a flange engaging strip.

Serpentine Frame

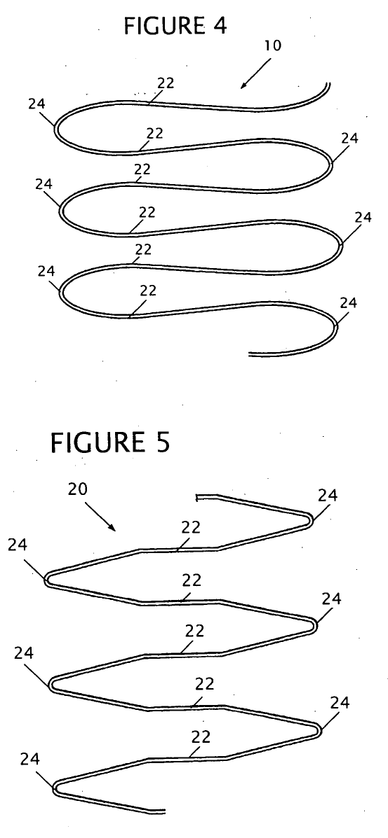

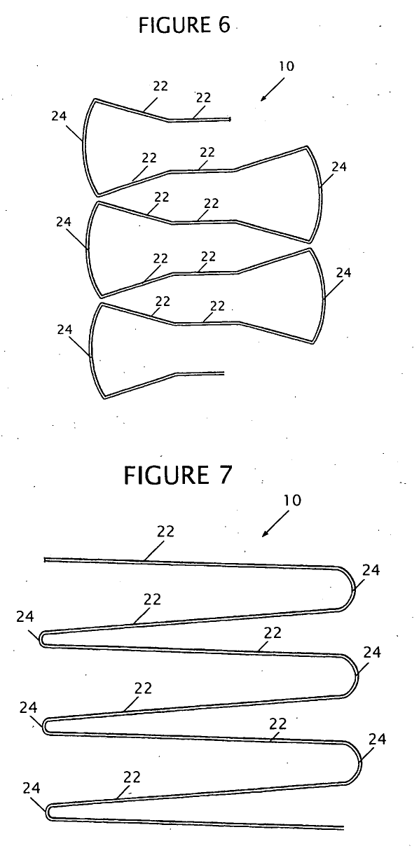

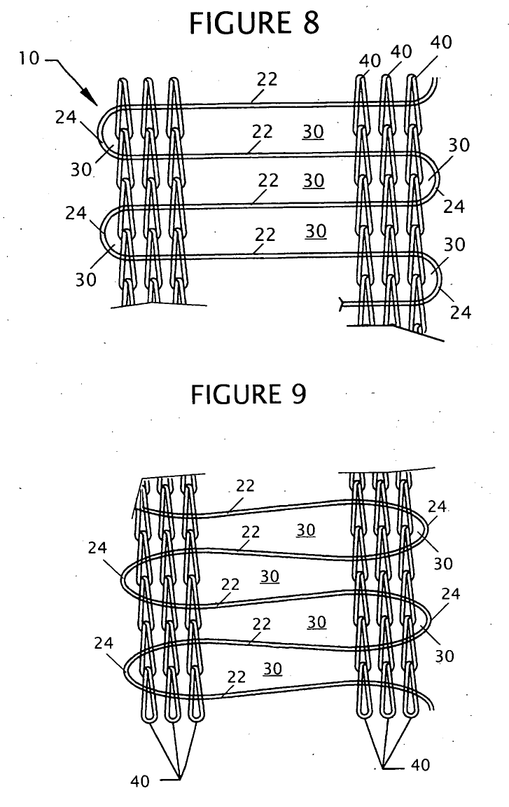

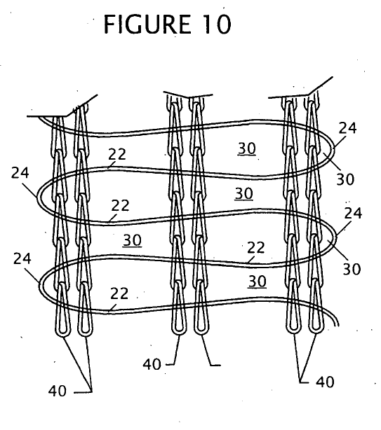

The serpentine frame 20 has a plurality of transversely extending limbs 22 interconnected at alternate ends by connecting regions 24. The limbs 22 can be straight or curvilinear, and can define sections that are linear, faceted, banana shaped, propeller shaped or any combination thereof. The limbs 22 are in a generally parallel relationship, such as adjacent limbs of FIGS. 1, 3 and 8, or alternating limbs are parallel as shown in FIGS. 4-7 and 9-10. The serpentine frame 20 has a width defined by the connecting regions 24 at the end of the limbs 22.

The serpentine frame 20 can be described in terms of the number of limbs 22 per inch (cm) and the length of the limbs. A range for limbs per inch (limbs per cm) is typically from approximately 4 to 12 limbs per inch (1.6 to 4.7 limbs per cm), with a usual range of about 7 to 10 limbs per inch (2.8 to 3.9 limbs per cm), and typical lengths of the limbs (across a width of the carrier assembly 10) range from approximately 0.5 inches (1.3 cm) to approximately 3 inches (7.6 cm).

Although the term “serpentine” frame 20 is used, the serpentine frame is intended to encompass any frame construction, wherein the limbs 22 and connecting regions 24 can have any of a variety of configurations including but not limited to, linear, curvilinear or faceted, wherein a longitudinal dimension of the frame extends generally transverse to the limbs.

The serpentine frame 20 is formed of a filament, or a plurality of filaments having sufficient resiliency to accommodate repeated flexing while having sufficient strength for the filament to retain a downstream formed shape, such as a U-shape transverse to the longitudinal dimension of the serpentine frame. The serpentine frame 20 can be formed of a metallic or non metallic filament. The non metallic filament materials include, but are not limited to plastics, elastomers, polymerics, ceramics or composites. Metallic filament materials include but are not limited to wires, alloys, steel, stainless steel, aluminum, galvanized metals, as well as composites.

For purposes of description, the serpentine frame 20 is set forth in terms of a metallic filament such as wire. However, it is understood, the description is applicable to any type of filament forming the serpentine frame 20.

The thickness of the wire is at least partially determined by the intended operating environment of the resulting strip as well as the configuration of the available extrusion tooling. Typically, the wire has a generally circular cross-section. However, it is understood the wire may have any of a variety of cross-sectional profiles, such as but not limited to obround, elliptical, faceted or triangular.

In one configuration of the wire, the wire has a diameter between approximately 0.010 inches (0.25 mm) and 0.050 inches (1.3 mm), wherein a further construction of the wire has a diameter of approximately 0.018 inches (0.46 mm) to 0.035 inches (0.89 mm). In yet another construction, the wire is a low carbon steel wire or 301 stainless steel having a diameter of about 0.030 inches (0.76 mm).

Referring to FIGS. 1 and 8-10, the warp 40 extends along the longitudinal dimension of the serpentine frame 20. The warp 40 can include a single strand or thread, or multiple strands or threads which can be separate or intertwined. The term “warp” is intended to encompass each of these configurations.

The warp 40 can be secured to the serpentine frame 20 by interlacing, which includes but is not limited to knitting or stitching such as crocheting, sewing, weaving or threading. Referring to FIGS. 1 and 8-10, the frame 20 and the warp 40 define a plurality of frame-warp apertures 30. The frame-warp apertures 30 have a periphery defined by the frame 20 and the warp 40. Depending upon the interlacing of the warp 40 and the frame 20, and the number of warps, the frame-warp apertures 30 can have a variety of sizes. Similarly, there can be a range in the number of frame-warp apertures 30 as defined by the number of limbs 22 per inch (cm), the number of warps 40 and the interlacing configuration.

In one configuration, the warp 40 encompass a portion of the serpentine frame 20 within a crocheted stitch. The warp 40 can be secured to the serpentine frame 20, such as with chain stitching and the warp is pre-tensioned, for example, from approximately 0.5 to 1.0 pounds (0.22 to 0.45 Kg) per warp end, with a satisfactory pre-tensioning of approximately 0.7 pounds (0.32 Kg). It is understood the stitching shown in FIGS. 1 and 8-10, is representative and that the warp 40 can engage the serpentine frame 20 by any of a variety of constructions.

Depending upon the interlacing of the warp 40 with the serpentine frame 20, intra-warp aperture and a stitch gap 37 can also be formed as seen in FIG. 1. The intra-warp aperture is entirely defined by the warp 40, rather than the warp and the serpentine frame 20, which define the frame-warp aperture and the stitch gap.

As seen in FIGS. 17-19, the serpentine frame 20 and the warp 40 form the stitch gap 37. The stitch gap 37 is located between the warp and an upstream surface of the filament and a downstream surface of the filament. That is, as the warp 40 passes above and below the serpentine frame 20 to then join (or stitch) intermediate adjacent limbs 22, the stitch gap 37 is formed between the warp and the frame. Referring to FIG. 17, the stitch gap 37 generally lies in a plane that is orthogonal to the longitudinal dimension of a local section of the filament. That is, for warps which are in substantially the same vertical plane, the stitch gap 37 is generally visible from an edge view of the carrier assembly 10, rather than a top or bottom plan view. In contrast, the frame-warp aperture 30 generally lies in the same plane as the serpentine frame 20, and is thus visible from a top or bottom plan view, rather than an edge or side view.

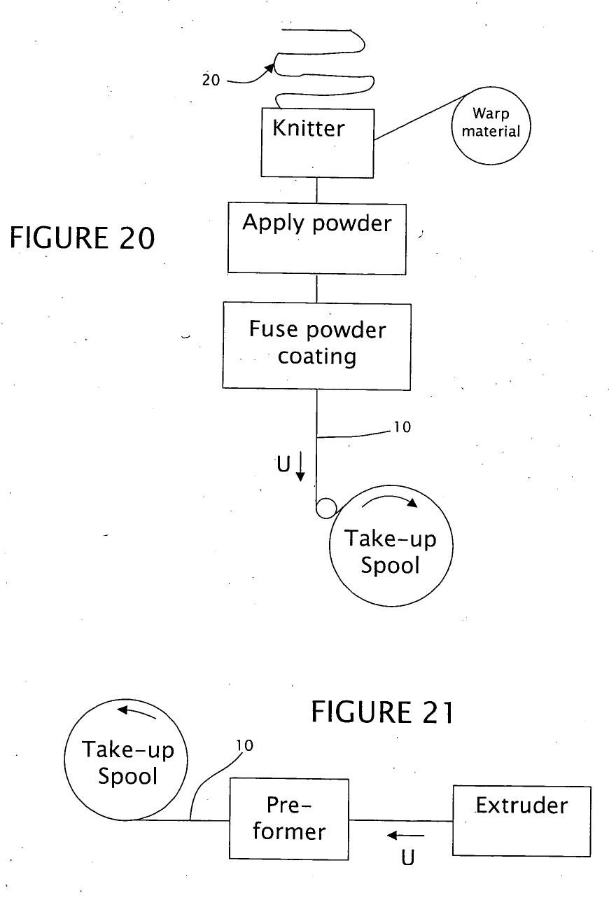

As the warp 40 is generally stitched to the serpentine frame 20, the warp exhibits a tendency to unravel along one longitudinal direction of the carrier assembly 10 and a lesser tendency to unravel along an opposite longitudinal direction of the carrier assembly. Depending upon the particular configuration of the warp “stitching,” the warp may exhibit only a single unraveling vector. That is, the warp 40 may bind up and actually tighten along one longitudinal direction of the carrier assembly 10, while unraveling along the opposite direction. As seen in FIG. 20, for purposes of description, an unraveling vector U is used to describe the direction (and magnitude or tendency) along which the unraveling of the warp 40 occurs. Referring to FIG. 20, the unraveling vector U extends along the direction of formation of the carrier assembly 10. That is, the unraveling would tend from an upstream location to a downstream location. The implications of the unraveling vector U are subsequently discussed in connection with the formation of the polymeric body 50.

The warp 40 can be threads strands, or yarns of any of a variety of materials, such as polymeric materials. The term polymeric is intended to encompass a polymer based on organic or organo-silicone chemistry. The warp can be a polymer, such as a synthetic resin or a natural fiber, such as cotton. Synthetic resins are advantageously more durable and resistant to, although not free from, the stresses incurred during embedding, for example during extrusion of the vehicular strip. Suitable polymeric materials for the warp 40 include, for example polyesters, polypropylenes and nylons, with polyesters being satisfactory. Polyester can have a relatively high degradation temperature of approximately 465° F. (240° C.). Since the temperatures reached during the normal processes of manufacturing the polymeric body 50 can be below approximately 240° C., the polyester material does not melt, soften or degrade. Consequently, in the finished composite strip 12, this type of warp material continues to effectively limit longitudinal displacement of the serpentine frame 20. The warp threads have a typical size of about 400 to about 3,000 denier, with a usual size between approximately 800 denier to approximately 2,000 denier.

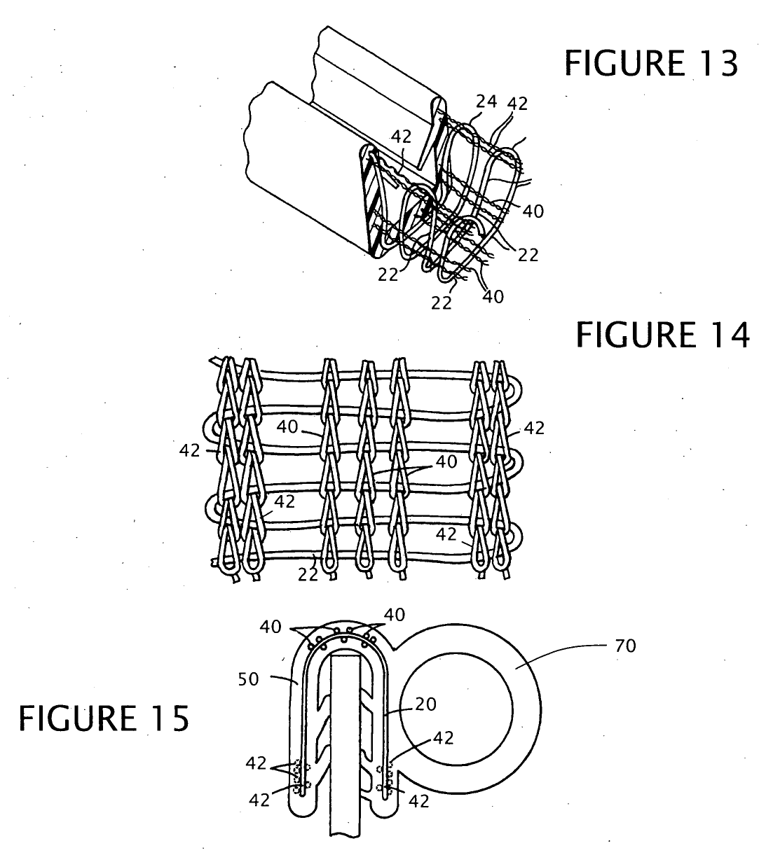

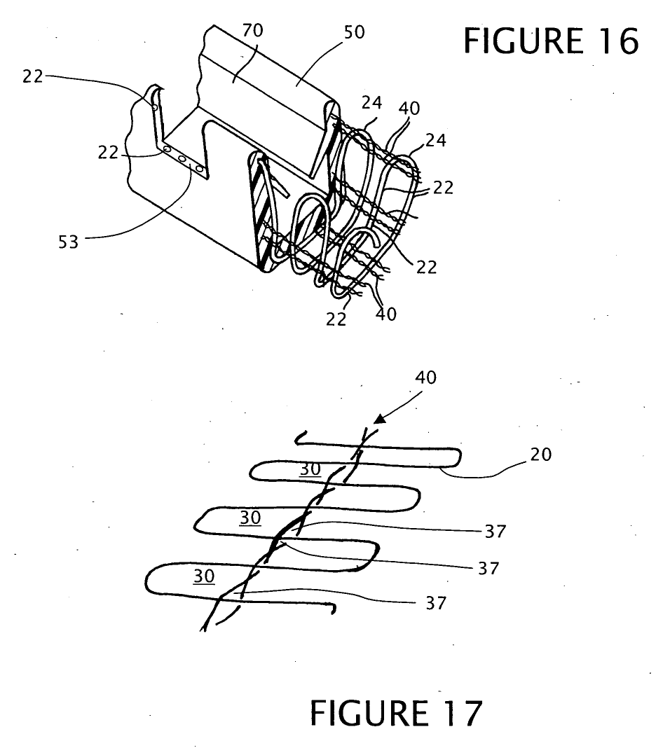

Referring to FIGS. 13-15, it is also contemplated the material of some of the warps 40, such as warps 42, can be selected to melt, or disintegrate, at a sufficiently low temperature so that the warps 42 can be effectively removed from the weatherstrip 12 after embedding in the polymeric body 50. These degradable, or phantom, warps 42 can be formed of polyethylene, which has a degradation temperature of approximately 240° F. (116° C.) which is lower than that of the polyester material of the remaining warps, but sufficiently high such that the polyethylene retains its reinforcing strength during at least the coating or embedding step of manufacturing the composite strip 12. However, during or after the composite strip 12 is made, the strip or local regions of the strip can be subjected to heat degradation at a temperature slightly higher than the degradation temperature, approximately 116° C. for the polyethylene. Accordingly, at such higher temperature, the warps 42 formed of polyethylene are melted or degraded more significantly than the polyester warp. When the finished composite strip 12 is flexed during installation on a flange or the like, the degraded warp material breaks or gives allowing increased flexibility of the strip while the more temperature resistant material warps retain their ability to inhibit longitudinal displacement of selected portions of the carrier assembly 10 and undue elongation or stretching of the strip. The term degradable is intended to encompass a material that is degradable to the extent that the reinforcing capacity of the material is eliminated or substantially reduced without degrading the remaining portions of the composite strip 12 including at least a part of the serpentine frame 20 and remaining material of the warp 40. Although the degradable warp 42 is typically located intermediate the warp 40 and the connecting regions 24, it is contemplated the warp 40 (non-degradable) can be located intermediate the degradable warp 42 and the connecting regions.

The fused powder 60 is located on, and bonded to at least one of the serpentine frame 20 and the warp 40. The fused powder 60 impedes or inhibits movement of the warp 40 relative to the serpentine frame 20 (along the transverse direction), thereby reducing warp drift, without the fused powder occluding the frame-warp aperture 30. In one configuration, the fused powder 60 constrains the warp 40 relative to the serpentine frame 20. The resistance to movement of the warp 40 relative to the serpentine frame 20 is created by contact between the warp and the fused powder 60. It is believed the contact between the warp 40 and the fused powder 60 can be created by the fused powder bonding to the serpentine frame 20, the fused powder bonding to the warp, or the fused powder bonding the warp to the serpentine frame.

The amount of contact between the fused powder 60 and the warp 40 is sufficient to reduce or retard movement of the warp relative to the serpentine frame 20, and particularly movement of the warp along a length of the limb 22. The contact between the fused powder 60 and the warp 40 can be provided by the fused powder substantially encapsulating the serpentine frame 20 and the warp 40. Alternatively, the fused powder 60 can be bonded to the serpentine frame 20, such as before the warp 40 is interlaced, and thus contact the warp upon interlacing. It is also contemplated the fused powder 60 can be primarily bonded to the warp 40.

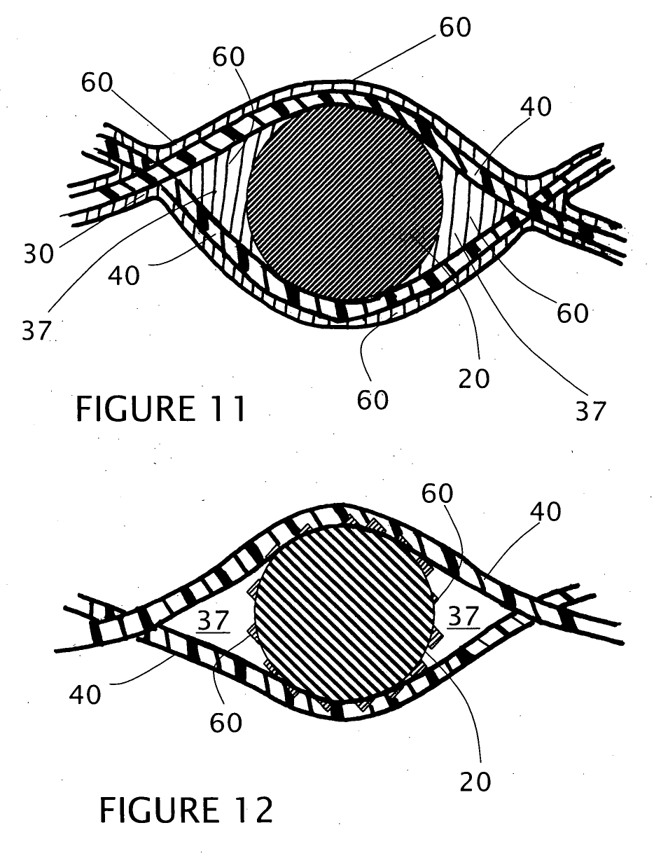

In one configuration, the fused powder 60 is on both the warp 40 and the serpentine frame 20 and effectively locks the warp to a position on the frame. The amount of fused powder 60 can range from the encapsulation of at least a portion of one of the serpentine frame 20 and the warp 40 seen in FIG. 11, to a discontinuous (broken) sputtering seen in FIG. 12. It is understood the carrier assembly 10 can include portions having the serpentine frame 20 and the warp 40 substantially encapsulated by the fused powder 60 (as seen in FIG. 11) and portions where the fused powder is on the surface of one component, such as the frame in FIG. 12. In all configurations, the amount of fused powder 60 is selected to substantially preserve the frame-warp aperture 30.

It is also contemplated the fused powder 60 can be initially located on one of the serpentine frame 20 or the warp 40, and subsequently remelted after interlacing the warp and the frame, so as to bond to both the warp and the frame.

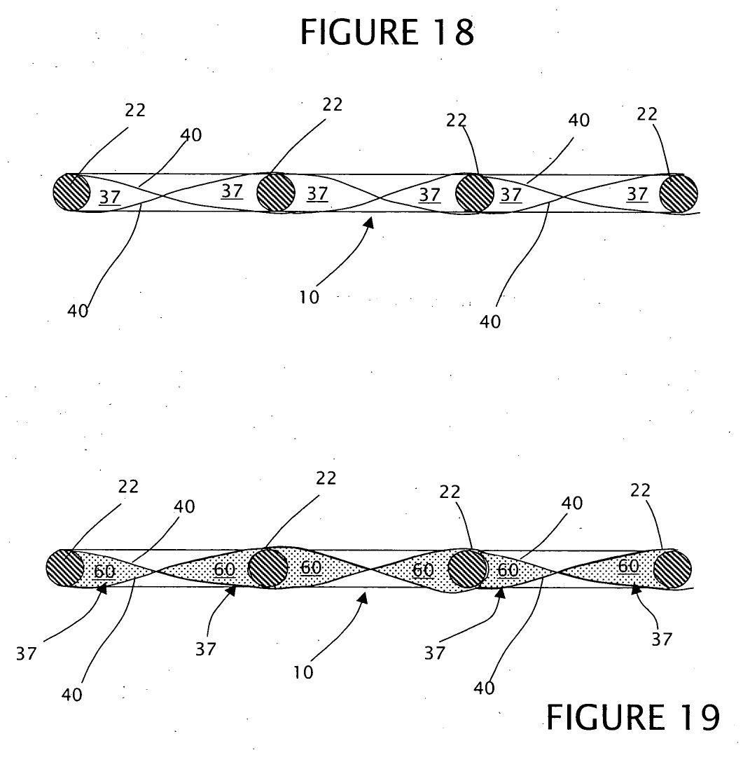

Referring to FIGS. 18 and 19, in a further configuration, the fused powder 60 is generally disposed within the stitch gaps 37. Thus, while the stitch gaps 37 are generally occluded or filled with the fused powder 60, the frame-warp apertures 30 and even the intra-warp apertures 35 can be substantially free of the fused powder. The fused powder 60 in the stitch gaps 37 has been found to sufficiently reduce movement of the warp 40 relative to the serpentine frame 20, substantially independent of the presence (or absence) of the fused powder in the frame-warp apertures 30 and/or the intra-warp apertures 35.

In addition, the fused powder 60 reduces the tendency of the warp 40 to unravel along the longitudinal dimension of the serpentine frame 20, and thus the fused powder shortens the unraveling vector U. While the inherent topology of certain stitching of the warp 40 can preclude unraveling in one longitudinal direction while permitting unraveling in the opposing longitudinal dimension of the carrier assembly 10, the fused powder 60 reduces the tendency of the warp to unravel (increases the resistance to unraveling along the unraveling vector U).

In each configuration of the carrier assembly 10, including the configuration of the fused powder 60 encapsulating at least one of the serpentine frame 20 and the warp 40, at least a percentage of the total number of frame-warp apertures 30 is preserved. That is, the fused powder 60 coats the exposed surfaces of the serpentine frame 20 and the warp 40, without occluding all the frame-warp apertures 30. Typically, at least 50% to 100% of the original number of frame-warp apertures 30 is preserved. It is understood certain configurations of the carrier assembly 10 can preserve as few as 10% of the total number of frame-warp apertures 30. That is, some of the frame-warp apertures 30 can be occluded by the fused powder 60, without blocking all the apertures. The initial area of a given frame-warp aperture 30 and the amount of fused powder 60 are factors in determining the percentage of the original frame-warp apertures 30 that remain after application of the fused powder 60.

Thus, the fused powder 60 can form a portion of the surface of the serpentine frame 20 or of the serpentine frame and the warp 40, wherein at least one frame-warp aperture 30 is substantially preserved. In the encapsulation configuration for a given frame-warp aperture 30, the fused powder 60 slightly extends into the frame-warp aperture, and occludes a portion of the aperture. Typically, at least 80% of the original area of the frame-warp apertures 30 in the carrier assembly 10 is preserved, with configurations of the carrier assembly 10 preserving 10% to 100% of the original area of the apertures. However, depending upon the initial area of the frame-warp aperture 30 and the amount of fused powder 60, a given aperture (or apertures of a certain area or smaller) can be occluded. In such configuration, the remaining frame-warp apertures 30 are of a sufficient area to preclude occlusion, thereby preserving at least one frame-warp aperture.

In a further configuration, the fused powder 60 is bonded to primarily the serpentine frame 20, with a minimal or insignificant amount of powder bonded to the warp 40. In this configuration, the fused powder 60 forms a rough surface on the serpentine frame 20, as seen in FIG. 12, and does not encapsulate the frame, but rather forms local discontinuities or areas of fused powder. The roughness imparted by the fused powder 60 is sufficient to inhibit or impede lateral movement of the warp 40 relative to the serpentine frame 20 and limb 22. Typically, such roughness is less than the diameter of the warp 40. Thus, for example, the fused powder 60 can create a surface roughness on the order of approximately 0.001 inches (0.0025 cm) to 0.010 inches (0.0254 cm). In this configuration, the fused powder 60 preserves a majority of the frame-warp apertures 30, and in certain constructions maintains over 90% of the total number of frame-warp apertures 30 and over 90% of the initial area of the frame-warp apertures of the carrier assembly 10.

Thus, a percentage of the total number of initial frame-warp apertures 30 and a percentage of the initial total area of the frame-warp apertures are preserved. Depending upon the configuration of the serpentine frame 20, the warp 40 and the fused powder 60, any of a variety of combinations of preserved number of frame-warp apertures 30 or preserved area of the frame-warp apertures can be provided.

Similarly, the occlusion (filling) or preservation of the stitch gaps 37 can be at least partially controlled in conjunction with the occlusion or preservation of the frame-warp apertures 30 and the intra-warp apertures 35.

Powders

The fused powder 60 can be a thermoplastic or thermoset. The thermoplastic powders do not chemically react in a heat phase, but rather soften and then re-solidify upon reduction of the temperature. Thermoset powders are applied and then cured, inducing a chemical cross-linking, thereby changing the fused powder 60 into a form that will not remelt.

The powders to be fused can be formulated to meet a variety of performance characteristics, including thickness, texture, color, hardness, chemical resistance, UV resistance or temperature resistance. The particle size of the powder can also be controlled in response to the desired performance of the fused powder 60.

A representative thermoplastic powder is polyethylene, having a melting point below a melting point of the serpentine frame 20 and the warp 40. In one configuration, the thermoplastic powder has a melting point of approximately 120° C.

A thermoset powder includes a thermosetting resin and a curing, or cross linking agent. A thermosetting resin for the fused powder can include epoxy resins, acrylic resins, phenol resins and polyester resins. These thermosetting resins can be used alone, or combined together with other resins. In particular, a thermosetting resin having an epoxy group (that is, glycidyl group), such as epoxy resins, acrylic resins are available. These thermosetting resins have excellent reactivity to a curing agent, even at relatively low temperatures, for example, approximately 120° C.

A latent curing agent such as dicyandiamide, imidazolines, hydrazines, acid anhydrides, blocked isocyanates, and dibasic acids can be added to the resin particles as a curing promoter. The latent curing agent is typically stable at room temperature, and crosslinks with a thermosetting resin in a range of 140° C. to 260° C. It is understood any of a variety of cross-linking agents can be employed.

For thermoplastic or thermoset powders, an additive or a functional material can be added to the resin particles, such as a filler including calcium carbonate, barium sulfate or talc; a thickener, for example silica, alumina or aluminum hydroxide; a pigment including titanium oxide, carbon black, iron oxide, copper phthalocyanine, azo pigments or condensed polycyclic pigments; a flowing agent such as silicone or acrylic oligomer, for example butyl polyacrylate; an accelerating agent such as zinc compounds; a wax such as polyolefin; a coupling agent including silane coupling; an antioxidant; or even an antimicrobial agent.

As the fused powder 60 can thus be colored, it is contemplated that different carrier assemblies 10 can be formed of different colors, thereby assisting in the incorporation of the appropriate carrier assembly for the given desired composite strip 12. That is, an operator can readily identify a particular carrier assembly 10 (with a particular warp construction) corresponding to a selected color, and thereby present the appropriate carrier assembly to an extruder.

Suitable powders to be fused are sold by Morton Powder Coating of Warsaw, Ind. and include DG-5001 CORVEL® BLUE (ethylene/Acrylic), DG-7001 CORVEL® BLACK 20 (Ethylene/Acrylic), 78-7001 CORVEL® BLACK (Nylon) and 70-2006 CORVEL® YELLOW (Nylon).

It is also contemplated the fused powder 60 can be selected to promote bonding with the embedding material of the subsequent vehicular strip 12. In such configurations, the powder includes a methacrylate coagent or a maleate.

Thus, the fused powder 60 can be constructed to retain the warp 40 relative to the serpentine frame 20, preserve the frame-warp aperture 30, bond to the embedding material of the vehicular strip 12 and insulate the frame.

The fused powder 60 is formed by retaining unfused powder on one of the serpentine frame 20 and the warp 40, and then fusing the powder. The powder can be temporarily disposed on the one of the serpentine frame 20 and the warp 40 by a variety of mechanisms including bonding agents, friction adhesion, or electrostatic attraction.

The bonding agents can be incorporated into the powder, or applied to the one of the serpentine frame 20 and the warp 40 in a desired location for the fused powder 60 prior to exposure of the frame and the warp to the powder.

Alternatively, a surface charge is formed on the one of the serpentine frame 20 and the warp 40, and the powder is oppositely charged, such that upon exposure of the oppositely charged powder to the surface charged portions of one of the frame and the warp, the powder is temporarily adhered.

To form the necessary surface charge on the one of the serpentine frame 20 and the warp 40, a potential is applied to the frame. It has been found that a sufficient potential can be applied to the serpentine frame 20 to create a charge sufficient to retain the powder prior to fusing.

By controlling the amount of powder exposed to the electrical potential difference between the powder and the surface charge on the one of the serpentine frame 20 and the warp 40, the amount of powder retained on the one of the serpentine frame 20 and the warp 40 can be controlled. As the amount of retained powder on the one of the serpentine frame 20 and the warp 40 at least partially determines the thickness of the fused powder 60, the thickness of the fused powder can thus be controlled.

Alternatively, the serpentine frame 20 and the warp 40 can be passed through a bath, or fluidized, vibrating bed of the powder to deposit the powder on the frame and the warp. The powdered serpentine frame 20 and warp 40 can then be subject to a controlled vibration or air jet to remove excess powder. Alternatively, the powder can be vibrated with the serpentine frame 20 and the warp 40 to deposit the powder. It is further contemplated that rollers can be used to deposit the powder on the serpentine frame 20 and the warp 40.

Further mechanisms for depositing the powder onto the serpentine frame 20 and the warp 40 include sprinkling the powder onto the frame and the warp, or passing the frame and the warp through a curtain of the powder. It is also contemplated the powder can be sprayed onto the serpentine frame 20 and the warp 40. The spray method can also involve imparting a charge to the powder, which is then electrostatically attracted to one of the serpentine frame 20 and the warp 40. Alternatively, a contact device, such as a roller can also be employed to deposit the powder onto the frame 20 and the warp 40.

It is also contemplated a retaining spray can be applied to one or both of the serpentine frame 20 and the warp 40 prior to exposure to the powder. The spray can be used to assist in the retention of the powder prior to fusing. The spray can be an adhesive itself, or can merely provide a temporary adhesive effect to retain the powder before fusing.

The temporarily retained or adhered powder is then melted and bonded to the serpentine frame 20 by a variety of options including radiative, convective, inductive or conductive heating. The bonding of the fused powder 60 to the serpentine frame 20 or the warp 40 is sufficient to inhibit movement of the warp relative to the limb 22.

The heating can be accomplished in a processing line downstream of the knitter (which formed the interlaced warp 40 and the serpentine frame 20) and a finished carrier assembly 10 take-up apparatus. Heating above the melting point of the meltable (or curable) powder causes the powder to bond to the serpentine frame 20 and/or the warp 40. On cooling, the melted powder hardens and the warp 40 is bonded in position. In one configuration, the warp 40 is bonded to the serpentine frame 20 and locked in a given position. In a different configuration, the fused powder 60 forms the roughened surface on the serpentine frame 20 which engage the warp 40. The carrier assembly 10 has a flat profile, is longitudinally stable and is virtually free of warp drift.

Heating of the frame 20, the warp 40 and the powder can be accomplished by a variety of methods which allow the powder to be heated close to or above the melting point of the powder. In one configuration, the heating above the melting point of the meltable powder is carried out for a period of time sufficient to cause the melted powder to at least partially flow about the junction of the warp 40 and the serpentine frame 20. Generally, the heating of the serpentine frame 20, the warp 40 and the powder can be accomplished by conductive, inductive, convective or radiative heating such as infrared, hot air or microwave. One method of heating includes exposing the serpentine frame 20, the warp 40 and the powder to a flow of heated air in an oven to fuse the powder without fusing or melting the warp. Another method comprises heating the serpentine frame 20, the warp 40 and the powder with infra-red radiation. A further method comprises passing the serpentine frame 20, the warp 40 and the powder over a heated roller. Another method contemplates induction heating of the serpentine frame 20. In yet another configuration, the heated serpentine frame 20, the warp 40 and the powder are passed between forming rolls. The roll treatment can also help to maintain the flat profile of the carrier assembly 10. The roll forming treatment can be applied during the heating process or immediately after the powder is fused.

Cooling of the carrier assembly 10 is accomplished by exposure to cooling jets or streams which can include air jets or ambient temperatures for a period of time after pulling the carrier assembly from the heater.

In contrast to powder coating the serpentine frame 20 interlaced with the warp 40, it is contemplated the fused powder 60 can be bonded to the filament prior to interlacing the warp 40. That is, the fused powder 60 is bonded to the filament, and the coated filament is formed into the serpentine frame and interlaced with the warp 40. The fused powder 60 thus mechanically engages the warp 40 and bonds to the serpentine frame 20.

In a further configuration, it is contemplated the fused powder 60 can be bonded to the warp 40 prior to interlacing with the filament.

Therefore, the process can include powder coating the serpentine frame 20 and the interlaced warp 40, interlacing the warp with a powder coated serpentine frame or interlacing a powder coated warp with the serpentine frame.

It is further contemplated that for thermoplastic fused powders 60 on one of the filament or the warp 40 prior to interlacing, the fused powder can be reheated after interlacing to induce the powder to fuse bond to the remaining component.

The invention provides a strong, physically and chemically stable carrier assembly 10, essentially free of warp drift which allows close grouping and selective positioning of adjacent warp 40, and allows grouping and bonding of different numbers of adjacent warps. Warp damage is minimized in the subsequent extrusion coating processes and, overall, greater control of the profile, appearance and quality of the product is achieved. The present process uses existing knitting equipment with a minimum of modification and is effective in reducing manufacturing costs.

Polymeric Body

As seen in FIGS. 2 and 15, the composite strip 12 can be configured as a flange engaging strip having the carrier assembly 10 and the polymeric body 50. Referring to FIG. 15, in one configuration, the flange engaging strip 12 has a generally U-shape cross section including a closed end 52 and a pair of limbs 54 projecting from the closed end, thereby defining a flange engaging channel 56. The U-shape cross section of the flange engaging channel 56 is sized to receive the flange of the vehicle.

The flange engaging strip 12 can include at least one grip fin 58 projecting from one limb 54 and extending into the flange engaging channel 56 to contact the flange. The grip fin 58 can assist in retention of the flange engaging strip 12 on the flange as well as orientation of the flange engaging strip on the flange. The flange engaging strip is not limited to any particular configuration having a single grip fin or a plurality of grip fins.

Depending upon desired performance characteristics of the flange engaging strip 12, the strip typically includes a plurality of grip fins 58 having a predetermined cross section, or predetermined area designed to contact the flange. In addition, the grip fins 58 can be formed of a material different from the remainder of the polymeric body 50. It is also contemplated that the grip fin 58 can have portions formed of different materials, such as different coefficients of friction, rigidity or compression resistance, so as to optimize performance of the grip fin, and hence the flange engaging strip.

In selected configurations such as FIGS. 2, 13 and 15, the flange engaging strip 12 includes a sealing member 70 to provide a sealed interface. The sealing member 70 can be connected to, or extend from the flange engaging strip. The sealing member 70 can have any of a variety of configurations such as bulb, flap, finger or fin.

Typically, the polymeric body 50 is a polymeric material which encapsulates the carrier assembly 10 (including the serpentine frame 20, the warp 40 (and warp 42 if employed) and the fused powder 60. The polymeric body 50 can be formed of any of a variety of materials including thermoplastic or thermosetting materials, including, but not limited to thermoplastic elastomers (TPE), EPDM, or any combination thereof. Satisfactory thermoplastic and TPE materials include PERMAPRENE™ by Metzeler Automotive Profile Systems, Sarlink® by DSM Thermoplastic Elastomers, Inc. of Massachusetts, Santoprene® by Advanced Elastomer Systems of Ohio and Uniprene® by Teknor Apex Company of Rhode Island. Suitable vulcanized or cross linked (thermosetting) polymeric materials include EPDM, EPDM modified with chloro butyl, and EPDM-SBR blends.

The grip fins 58 and the sealing member 70 can be formed of the same or different material than the body 50.

The ability to control the location of the warp 40 relative to the serpentine frame 20 allows for the reduction in the number of necessary warps. For example, as seen in FIGS. 21 and 23, the carrier assembly 10 can be passed through a pre-former which imparts a bend in the cross sectional profile of the assembly. The pre-former typically includes at least a pair of rollers defining a nip therebetween. By controlling the orientation of the nip, the pre-former can impart various shapes to the carrier assembly 10. However, in prior constructions, if a warp drifted so as to be located in the nip of the pre-former, the warp was usually damaged, if not severed. Such loss of warp, negatively impacted any resulting composite strip by inducing any of a variety of defects such as blisters, bubbles, gaps, holes as well as uneven cross section along the longitudinal dimension of the strip. In prior constructions, such destruction of the warps was often addressed by increasing the number of warps, thereby increasing the probability that a sufficient number warps would withstand the pre-former. However, this excess number of warps increased cost and weight of the carrier as well as requiring additional material to embed the carrier.

As the fused powder 60 precludes material drift of the warps 40, the carrier assembly 10 can be designed, and now formed, so that the warps are located and maintained at positions on the serpentine frame 20 that do not pass through the nip of the pre-former. Thus, the number of warps can be reduced without sacrificing the stability or functionality of the resulting carrier assembly 10 and hence composite strip 12. Reduction in the number of warps 40 reduces both weight and cost of the resulting carrier assembly 10. In addition, the reduced number of warps 40 allows the carrier assembly 10 to be embedded within a reduced amount of polymeric material.

It is also contemplated the amount of fused powder 60 can be selected to reduce or minimize de-spragging of the carrier assembly 10. That is, absent the fused powder 60, upon cutting the serpentine frame 20, the free end of the serpentine frame 20 (the filament) tends to straighten and can form an undesirable projection which can interfere with subsequent operator and machine handling of the carrier assembly 10. It is believed the fused powder 60 can provide sufficient retentive force on the carrier assembly 10 to substantially preclude the free end of the serpentine frame 20 (the filament) pulling from the warp 40. Thus, the previously required step of de-spragging the cut carrier assembly 10 is obviated.

In addition, it is believed the fused powder 60 on the warp 40 reduces a tendency of the warp to fluff or fray upon the carrier assembly 10 (and the warp) being cut to length. Reducing the fluff of the cut warp 40 reduces the tendency of the carrier assembly 10 (and the warp) to absorb moisture, and improves subsequent embedding of the carrier assembly, thereby providing a more satisfactory finished product.

The application of the fused powder 60 to the material of the warp 40 is also believed to reduce the amount of moisture retention in the warp at the time of embedding in the polymeric body 50. It is believed the heating of the warps 40 to form the fused powder 60 drives at least some of the moisture from the warp material. The reduced amount of moisture reduces blistering during formation of the polymeric body 50. It is also contemplated sufficient moisture may be driven from the warp 40 during the powder fusing process, that pre-heaters typically associated with the extrusion process of the polymeric body 50 are no longer required.

The carrier assembly 10 is particularly useful as reinforcement for elastomeric (polymeric) vehicular strip 12 for example, flange engaging strips including trunk seals, door seals or edge protector strips as well as glass run channels, and sun roof seals. The carrier assembly 10 is advantageous for extrusion processes due to the control or virtual absence of warp drift and longitudinal stability under the conditions of the extrusion process. The carrier assembly 10 provides for positioning of the warp 40 or warps, at the parts of the strip requiring the most reinforcement, for example, the base or the sides of a subsequently formed U-shape channel.

Referring to FIG. 20, upon emerging from the knitter, which interlaces the warp 40 and the serpentine frame 20, the unraveling vector U extends downstream along the emerging carrier assembly 10. That is, if the leading edge of the carrier assembly 10 were subjected to an unraveling influence, the warp 40 would not unravel as the unraveling vector is directed in the opposite direction. This is the historically desired orientation of the unraveling vector U as any unraveling will not migrate upstream along the carrier assembly 10 during the extrusion of the polymeric body 50. Any unraveling is self contained. However, if the unraveling vector U were directed upstream, as seen in FIG. 21, any unraveling of the warp 40 would tend to migrate upstream into the spool, potentially unraveling the entire length of the upstream carrier assembly 10.

If the knitter were directly ahead of the extruder (and any associated pre-former) along a common processing line, the carrier assembly 10 could be introduced from the knitter into the extruder, as the unraveling vector U is directed downstream.

However, the knitter is in a separate facility than the extruder the carrier assembly 10 must be retained on a take-up spool as the carrier assembly emerges from the knitter. As the carrier assembly 10 is wound about the take-up spool, the resulting free end of the carrier assembly cannot be directly introduced into the extruder as the unraveling vector U is directed upstream (or into the spool). If the carrier assembly 10 were introduced from the take-up spool into the extruder in such direction, and unraveling of the warp were to start, the unraveling would propagate upstream along the carrier assembly rendering such length unusable. Such unraveling can migrate a substantial distance up the carrier assembly 10. As well as losing product, such unraveling requires re-stringing of the extrusion line and accompanying system down time.

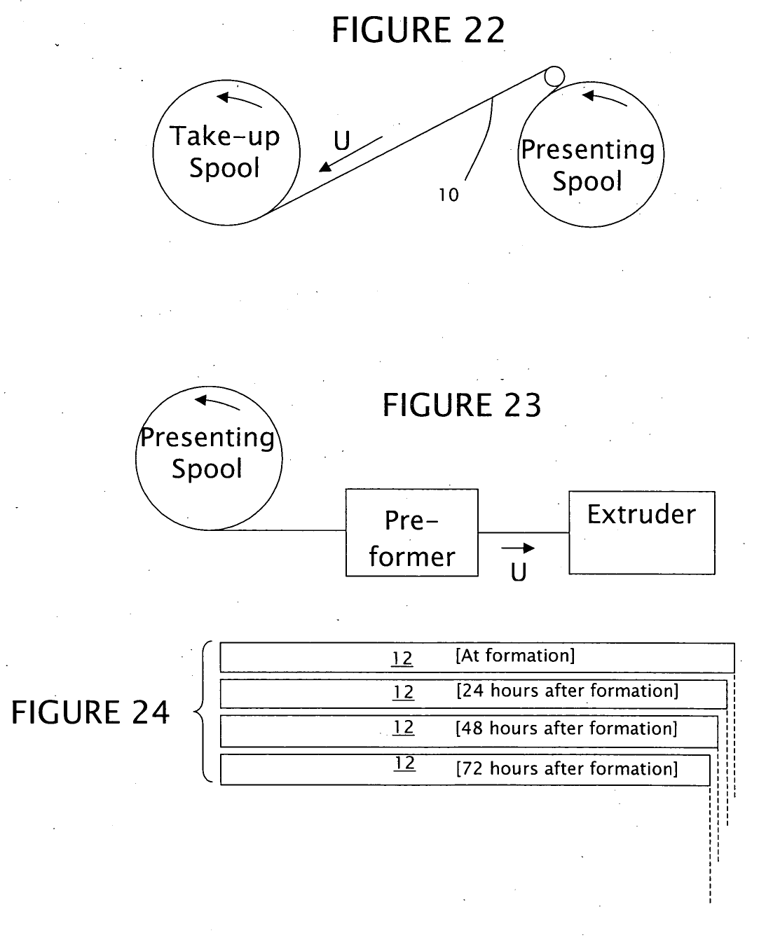

Therefore, as seen in FIG. 22, prior wire carriers are rewound from the take-up spool to a presenting spool, so as to reorient the wire carrier such that the unraveling vector extends from the resulting free end of the wire carrier, as the re-wound carrier is disposed about the presenting spool. This required rewinding of the wire carrier from the take-up spool to the presenting spool increases manufacturing time and cost of the resulting wire carrier.

It is believed the fused powder 60 sufficiently reduces the unraveling vector U so the carrier assembly 10 can be presented (via the pre-former if desired) to the extruder directly from the take-up spool. That is, the unraveling vector U can be directed upstream, shown in FIG. 21, as the carrier assembly 10 is introduced into the extruder, wherein the extruder can include the pre-former as well as any station known in the extrusion art. When subject to an unraveling force, the fused powder 60 sufficiently inhibits migration of the unraveling upstream in the carrier assembly 10 so that extrusion of the polymeric body 50 can continue uninterrupted. Thus, no re-winding of the carrier assembly 10 from a take-up spool to a presentating spool is required.

In subsequent formation of the vehicular strip 12 the preserved frame-warp aperture 30 is filled by the embedding material of the strip during a conventional extrusion or molding processes. The material embedding the carrier assembly 10 is typically a polymeric material, such as for example, a thermoplastic or thermosetting elastomer. Generally, the carrier assembly 10 is fed through an extruder, as well known in the art, wherein a polymeric material is extruded about the carrier assembly 10 so as to embed the carrier assembly within the polymeric material. To provide satisfactory embedding of the carrier assembly 10, the embedding material must “strike through” the frame-warp aperture 30. That is, the embedding material must flow through the frame-warp aperture 30, thereby entirely embedding the cross section of the carrier assembly 10.

In the configuration in which it is the stitch gaps 37 that are primarily filled with the fused powder 60, the polymeric body 50 occupies substantially all the frame-warp apertures 30 as well as the intra-frame apertures 35. This improved penetration of the polymeric body 50 improves the quality of the resulting polymeric body, by reducing the presence of pin holes in the polymeric body.

Further, as the carrier assembly 10 incorporates constant location of the warp 40, the resulting composite strip 12 has a constant, predictable behavior and exhibits less tendency to twist or spiral about the longitudinal axis. The constant location of the warps 40 results in constant retention force along the longitudinal dimension of the composite strip 12 upon installation of the composite strip and hence a consistency in the flange receiving channel 56 is provided. Thus, upon forming the U-shape flange engaging channel 56 in the composite strip 12, the flange engaging channel has a consistent cross section without twisting which would change the width of the channel and hence insertion and/or retention force of the composite strip.

The stable, constant, location of the warp 40 in the designed location also creates a flatter carrier assembly 10. As the carrier assembly 10 lies within a reduced thickness, the corresponding extrusion die for forming the polymeric body 50 can be a reduced thickness, thereby reducing material usage. That is, rather than employing an enlarged die to provide sufficient thickness of the embedding body to accommodate twist or undulations of the wire carrier, the present flatter carrier assembly 10 can be extruded in a thinner die, while ensuring coverage by the polymeric body 50. Specifically, the carrier assembly 10 can be embedded within the polymeric body 50, wherein the polymeric body has a thickness that is less than that required to correspondingly embed a wire carrier formed without the fused powder 60. That is, if a length of serpentine frame 20 and warp 40 were formed, wherein a first longitudinal section included the fused powder 60 and a second longitudinal section did not include the fused powder, the section with the fused powder (being flatter) can be extruded through a thinner die orifice while providing at least substantially the same coverage as a thicker die orifice extruding on the second section.

The composite strip 12 having the carrier assembly 10 and polymeric body 50 also exhibits a reduced contraction after formation. Specifically, if a length of serpentine frame 20 and warp 40 were formed, wherein a first longitudinal section included the fused powder 60 and a second longitudinal section did not include the fused powder and the entire length were embedded in a polymeric body 50 to form a composite strip, the section of the composite strip having the carrier assembly with the fused powder would shrink less in the longitudinal direction than the section of the composite strip embedding the carrier assembly without the fused powder.

The stable location of the warp 40 relative to the serpentine frame 20 and hence polymeric body 50 can also provide for a reduction in the number of required limbs 22 per inch. It has been found that the present carrier assembly 10 having approximately one limb 22 less for each two inches of assembly (or one-half limb per inch), yields substantially the same performance and handling characteristics as prior wire carriers having the additional one-half limb per inch.

The composite strip 12 can be employed along generally linear installations. The composite strip 12 can also be located about a radiused path or corner. In such constructions, it has been found advantageous to (i) degrade the degradable warps 42 or (ii) remove a portion of the embedding polymeric body 50 (and any underlying portion of the carrier assembly 10) to form a notch 53, so as to allow ready bending of the strip 12. The notch 53 in the composite strip 12 also provides for a molding or over molding about notched area. As the notch 53 removes material, the composite strip 12 can be angled without distorting adjacent sections of the strip. The notch 53 is generally a recess extending from a lateral edge of the composite strip 12 (or the polymeric body 50) toward an opposing edge, wherein the notch extends along a longitudinal dimension of the composite strip.

With prior wire carriers, the inherent drift of the warps could result in a portion of the warp being exposed in a notch. Such exposed warp negatively impacted a subsequent overmolding of the notch area. Thus, as the carrier assembly 10 provides predictable and consistent locations of the warp 40 within the polymeric body 50, the notch 53 can be formed while ensuring there is no exposure to the warp. Since the warp 40 is located at a consistent position with respect to the serpentine frame 20, upon forming the notch 53, a portion of the polymeric body 50 remains between the notch and the embedded warp. Alternatively, if fused powder 60 were sufficient, the notch 53 could expose a portion of the warp without introducing detrimental fraying of the warp 40.

While the invention has been described in conjunction with specific embodiments thereof, it is evident that many alternatives, modifications, and variations will be apparent to those skilled in the art in light of the foregoing description. Accordingly, the present invention is intended to embrace all such alternatives, modifications, and variations as fall within the spirit and broad scope of the appended claims.

1. A carrier assembly comprising:
(a) a serpentine frame;
(b) at least one warp contacting the frame along a longitudinal dimension of the frame and defining at least one frame-warp aperture; and
(c) a fused powder on at least one of the frame and the warp, the fused powder maintaining at least one frame warp aperture.

2. The carrier assembly of claim 1, wherein the fused powder substantially encapsulates at least one of the warp and the serpentine frame.

3. The carrier assembly of claim 1, wherein the fused powder substantially encapsulates the warp and the serpentine frame.

4. The carrier assembly of claim 1, further comprising a degradable warp.

5. The carrier assembly of claim 4, wherein the degradable warp is meltable.

6. The carrier assembly of claim 1, further comprising an elongate polymeric body at least partially embedding the serpentine frame, the warp and the fused powder.

7. The carrier assembly of claim 6, wherein the polymeric body includes a notch.

8. The carrier assembly of claim 6, wherein the polymeric body includes a notch, the notch being spaced from the warp by a portion of the polymeric body.

9. The carrier assembly of claim 6, wherein the polymeric body includes a notch, a portion of the warp being exposed in the notch.

10. The carrier assembly of claim 1, wherein the warp defines a plurality of stitch gaps and a plurality of frame-warp apertures, the fused powder substantially occluding the plurality of the stitch gaps and preserving the plurality of the frame-warp apertures.

11. The carrier assembly of claim 10, further comprising an elongate polymeric body at least partially embedding the serpentine frame, the warp and the fused powder to form a composite strip, wherein the polymeric body extending through the frame-warp apertures.

12. The carrier assembly of claim 11, wherein a longitudinal dimension of the composite strip shrinks less than a longitudinal dimension of a corresponding composite strip having a carrier assembly free of fused powder.

13. The carrier assembly of claim 11, wherein a thinner polymeric body embeds the carrier assembly having the fused powder than a carrier assembly free of the fused powder.

14. The carrier assembly of claim 1, wherein the fused powder is of a first predetermined color.

15. The carrier assembly of claim 1, further comprising a spool, and a length of the carrier assembly being wound about the spool.

16. The carrier assembly of claim 15, wherein the carrier assembly has a bound end proximal to the spool and a free end.

17. The carrier assembly of claim 16, wherein the carrier assembly has a first tendency of longitudinal unraveling from the free end to the bound end and a lesser second tendency of longitudinal unraveling extending from the bound end to the free end.

18. The carrier assembly of claim 16, wherein the carrier assembly has a first tendency of longitudinal unraveling from the free end to the bound end and a greater second tendency of longitudinal unraveling extending from the bound end to the free end.

19. A method of forming a carrier assembly, the method comprising fusing a powder to at least one of a serpentine frame and a warp extending along a longitudinal dimension of the frame, the fused powder preserving a frame-warp aperture.

20. The method of claim 19, further comprising substantially encapsulating at least one of the warp and the serpentine frame with the fused powder.

21. The method of claim 19, further comprising substantially encapsulating the warp and the serpentine frame.

22. The method of claim 19, further comprising including a degradable warp connected to the serpentine frame.

23. The method of claim 19, further comprising including a meltable warp connected to the serpentine frame.

24. The method of claim 19, further comprising at least partially embedding the serpentine frame, the warp and the fused powder in a polymeric body.

25. The method of claim 19, further comprising forming a notch in the polymeric body.

26. The method of claim 19, further comprising forming a notch in the polymeric body and spacing the warp from the notch by a portion of the polymeric body.

27. The method of claim 19, further comprising forming a notch in the polymeric body and exposing a portion of the warp in the notch.

28. The method of claim 19, further comprising defining a plurality of stitch gaps and a plurality of frame-warp apertures between the warp and the serpentine frame, and substantially filling the plurality of the stitch gaps with the fused powder and preserving the plurality of the frame-warp apertures.

29. The method of claim 19, further comprising at least partially embedding the serpentine frame, the warp and the fused powder in a polymeric body to form a composite strip, and extending the polymeric body through the frame-warp apertures.

30. The method of claim 19, further comprising embedding the carrier assembly in a polymeric body to form a composite strip, the carrier assembly having sufficient fused powder to shrink in the longitudinal direction less than a corresponding composite strip and carrier assembly free of fused powder.

31. The method of claim 19, further comprising embedding the carrier assembly in a thinner polymeric body than can embed the carrier assembly free fused powder.

32. The method of claim 19, further comprising coloring the fused powder a first predetermined color.

33. The method of claim 19, further comprising winding a length of the carrier assembly about a spool.

34. The method of claim 19, further comprising winding a length of the carrier assembly about a spool to provide a bound end proximal to the spool and a free end.

35. The method of claim 19, further comprising winding a length of the carrier assembly about a spool to provide a bound end proximal to the spool and a free end, the carrier assembly having a first tendency of longitudinal unraveling from the free end to the bound end and a lesser second tendency of longitudinal unraveling extending from the bound end to the free end.

36. The method of claim 19, further comprising winding a length of the carrier assembly about a spool to provide a bound end proximal to the spool and a free end, the carrier assembly having a first tendency of longitudinal unraveling from the free end to the bound end and a greater second tendency of longitudinal unraveling extending from the bound end to the free end.
